(19) United States
(12) Patent Application Publication
(10) Pub. No.: US 2025/0182680 A1
(43) Pub. Date: Jun. 5, 2025

(54) Display Apparatus

(71) Applicant: LG Display Co., Ltd., Seoul (KR)

(72) Inventors: Namwook Cho, Paju-si (KR); SeongYeong Kim, Paju-si (KR)

(21) Appl. No.: 18/909,451

(22) Filed: Oct. 8, 2024

(30) Foreign Application Priority Data
Nov. 30, 2023 (KR) 10-2023-0170732

(51) Int. Cl. G09G 3/32

(52) U.S. Cl. CPC G09G 3/32; G09G 2300/0465; G09G 2310/0275

(57) ABSTRACT

A display apparatus is provided, which comprises a display panel having a display area in which a plurality of subpixels are disposed, wherein each of the plurality of subpixels includes a driving transistor connected to a first power line, an emission control transistor connected to the driving transistor and supplied with an emission control signal, a plurality of mode control transistors connected to the emission control transistor, and first and second light emitting elements connected to the plurality of mode control transistors, and the plurality of mode control transistors include (1-1)th and (1-2)th mode control transistors connected in parallel with each other, and (2-1)th and (2-2)th mode control transistors connected in series with each other.

### CROSS-REFERENCE TO RELATED APPLICATION

This application claims the benefit of the Republic of Korea Patent Application No. 10-2023-0170732 filed on Nov. 30, 2023, which is hereby incorporated by reference in its entirety.

### FIELD OF TECHNOLOGY

The present disclosure relates to a display apparatus.

### DESCRIPTION OF THE RELATED ART

A display apparatus is widely used as a display screen of a laptop computer, a tablet computer, a smart phone, a portable display device, and a portable information device in addition to a display screen of a television or a monitor. Recently, there is an increasing need for a large-scaled display apparatus for a large-scaled electronic device such as an automobile.

Such a large-scaled display apparatus has a plurality of display areas, and a method capable of freely adjusting a ratio of each display area in accordance with a user's request or a display image will be required.

### SUMMARY

The present disclosure has been made in view of the above problems and it is an object of the present disclosure to provide a display apparatus in which a ratio of a plurality of display areas may be adjusted.

In addition to the objects of the present disclosure as mentioned above, additional objects and features of the present disclosure will be clearly understood by those skilled in the art from the following description of the present disclosure.

In one embodiment, a display apparatus comprises: a display panel having a display area in which a plurality of subpixels are disposed, each of the plurality of subpixels including: a driving transistor connected to a first power line; an emission control transistor connected to the driving transistor, the emission control transistor supplied with an emission control signal at a gate electrode of the emission control transistor; a first light emitting element; a second light emitting element, and a plurality of mode control transistors connected to the emission control transistor, the first light emitting element, and the second light emitting element, the plurality of mode control transistors including: a plurality of first mode control transistors connected in parallel with each other and connected to the first light emitting element; and a plurality of second mode control transistors connected in series with each other and connected to the second light emitting element.

In one embodiment, a display apparatus comprises: a display panel having a display area in which a plurality of subpixels are disposed, the display area including a first display area and a second display area that is an area of the display area that excludes the first display area, wherein the display panel is driven in a first mode and a second mode such that the first display area emits light and the second display area does not emit light in the first mode and the second display area emits light and the first display area does not emit light in the second mode.

In one embodiment, a display apparatus comprises: a display panel having a first display area that emits light during a first mode but not during a second mode and a second display area that emits light during the second mode but not during the first mode, and a plurality of subpixels are disposed in the first display area and the second display area, each of the plurality of subpixels including: a driving transistor connected to a first power line; an emission control transistor connected to the driving transistor, the emission control transistor supplied with an emission control signal at a gate electrode of the emission control transistor; a first light emitting element; a second light emitting element, and a plurality of mode control transistors including: a plurality of first mode control transistors connected in parallel with each other and connected to the first light emitting element; and a plurality of second mode control transistors connected in series with each other and connected to the second light emitting element, wherein the first light emitting element emits light and the second light emitting element does not emit light in the first mode, and the second light emitting element emits light and the first light emitting element does not emit light in the second mode.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic view illustrating a configuration of a display apparatus according to one embodiment of the present disclosure;

FIGS. 2A to 2D are views illustrating various forms in which a ratio of first and second display areas is changed in a display apparatus according to one embodiment of the present disclosure;

FIG. 3 is a circuit view illustrating one subpixel of a display apparatus according to one embodiment of the present disclosure;

FIGS. 4A and 4B are views illustrating driving areas of first and second modes according to a plurality of control signals in a display apparatus according to one embodiment of the present disclosure;

FIG. 5 is a plan view illustrating an arrangement structure of a subpixel in a display apparatus according to one embodiment of the present disclosure;

FIG. 6 is a view illustrating an arrangement structure of a plurality of mode signal supply lines in a display apparatus according to one embodiment of the present disclosure;

FIG. 7 is a view illustrating an arrangement structure of a plurality of mode signal supply lines in a display apparatus according to another embodiment of the present disclosure;

FIG. 8 is a view illustrating an arrangement structure of a plurality of mode signal supply lines in a display apparatus according to other embodiment of the present disclosure; and

FIG. 9 is a view illustrating a schematic arrangement structure of a plurality of blocks in a display apparatus according to one embodiment of the present disclosure.

### DETAILED DESCRIPTION

Advantages and features of the present disclosure and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete and will fully convey the scope of the present disclosure to those skilled in the art. Further, the present disclosure is only defined by scopes of claims.

A shape, a size, a ratio, an angle and a number disclosed in the drawings for describing embodiments of the present disclosure are merely an example and thus, the present disclosure is not limited to the illustrated details. Like reference numerals refer to like elements throughout the specification. In the following description, when the detailed description of the relevant known function or configuration is determined to unnecessarily obscure the important point of the present disclosure, the detailed description will be omitted. In a case where ‘comprise’, ‘have’ and ‘include’ described in the present disclosure are used, another portion may be added unless ‘only˜’ is used. The terms of a singular form may include plural forms unless referred to the contrary.

In construing an element, the element is construed as including an error band although there is no explicit description.

In describing a position relationship, for example, when the position relationship is described as ‘upon˜’, ‘above˜’, ‘below˜’ and ‘next to˜’, one or more portions may be disposed between two other portions unless ‘just’ or ‘direct’ is used.

In describing a temporal relationship, for example, when the temporal order is described as “after,” “subsequent,” “next,” and “before,” a case which is not continuous may be included, unless “just” or “direct” is used.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

Features of various embodiments of the present disclosure may be partially or overall coupled to or combined with each other and may be variously inter-operated with each other and driven technically as those skilled in the art can sufficiently understand. The embodiments of the present disclosure may be carried out independently from each other or may be carried out together in a co-dependent relationship.

Hereinafter, the preferred embodiment of the present disclosure will be described in detail with reference to the accompanying drawings.

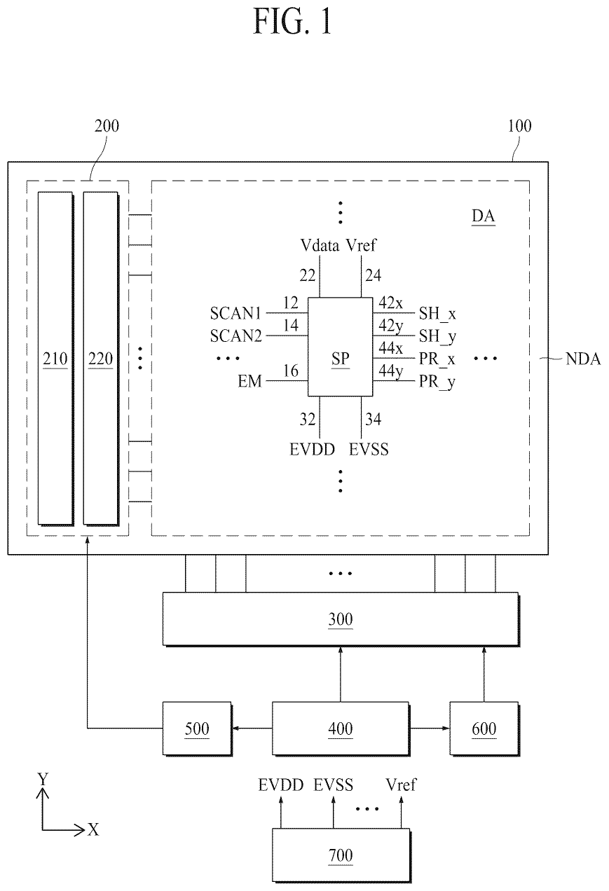

FIG. 1 is a schematic view illustrating a configuration of a display apparatus according to one embodiment.

The display apparatus according to one embodiment may be an electroluminescent display apparatus that includes an organic light emitting diode (OLED) display apparatus, a quantum-dot light emitting diode display apparatus or an inorganic light emitting diode display apparatus.

Referring to FIG. 1, the display apparatus according to one embodiment may include a display panel 100, a gate driver 200, a data driver 300, a timing controller 400, a level shifter 500, a gamma voltage generator 600 and a power management circuit 700. In this case, the data driver 300, the timing controller 400, the level shifter 500 and the gamma voltage generator 600 may be integrated into a display driver.

The display panel 100 may be a flat panel display panel, or may be a flexible display panel, of which shape may be modified, such as a foldable, bendable, rollable or stretchable display panel.

The display panel 100 may include a display area DA for displaying an image and a non-display area NDA surrounding the display area DA. The non-display area NDA does not display an image.

The display area DA may include a plurality of subpixels SP arranged in the form of a matrix. A subpixel matrix disposed in the display area DA may include a plurality of row lines and a plurality of column lines, which are comprised of a plurality of subpixels SP.

Each subpixel SP may be any one of a red subpixel for emitting red light, a green subpixel for emitting green light, a blue subpixel for emitting blue light and a white subpixel for emitting white light. Also, a unit pixel may include at least two subpixels SP.

The display area DA may include a plurality of signal lines connected to each subpixel SP. The plurality of signal lines may include a plurality of gate lines 12, 14 and 16, a data line 22, a plurality of power lines 24, 32 and 34, and a plurality of mode control lines 42x, 42y, 44x and 44y.

The plurality of gate lines 12, 14 and 16 may include first and second scan lines 12 and 14 and an emission control line 16. Each of the first and second scan lines 12 and 14 may supply first and second scan signals SCAN1 and SCAN2 supplied from the gate driver 200 to each subpixel SP, and the emission control line 16 may supply an emission control signal EM supplied from the gate driver 200 to each subpixel SP.

The data line 22 may supply a data voltage Vdata supplied from the data driver 300 to each subpixel SP.

The plurality of power lines 24, 32 and 34 may include an initialization voltage line 24, a first power line 32 and a second power line 34. The initialization voltage line 24 may supply an initialization voltage Vref supplied from the power management circuit 700 to each subpixel SP, the first power line 32 may supply a high potential voltage EVDD to each subpixel SP, and the second power line 34 may supply a low potential voltage EVSS that is less than the high potential voltage EVDD to each subpixel SP.

The plurality of mode control lines 42x, 42y, 44x and 44y may include a (1-1)th mode control line 42x (e.g., a first mode control line), a (1-2)th mode control line 42y (e.g., a second mode control line), a (2-1)th mode control line 44x (e.g., a third mode control line), and a (2-2)th mode control line 44y (e.g., a fourth mode control line). The (1-1)th mode control line 42x may supply a (1-1)th mode control signal SH_x (e.g., a first mode control signal) supplied from the data driver 300 or a separate mode controller (not shown) to each subpixel SP, and the (1-2)th mode control line 42y may supply a (1-2)th mode control signal SH_y (e.g., a second mode control signal) supplied from the data driver 300 or a separate mode controller to each subpixel SP. Also, the (2-1)th mode control line 44x may supply a (2-1)th mode control signal PR_x (e.g., a third mode control signal) supplied from the data driver 300 or a separate mode controller (not shown) to each subpixel SP, and the (2-2)th mode control line 44y may supply a (2-2)th mode control signal PR_y (e.g., a fourth mode control signal) supplied from the data driver 300 or a separate mode controller to each subpixel SP.

The display apparatus or the display panel 100 may selectively drive first and second light emitting elements of each subpixel SP through the plurality of mode control signals SH_x, SH_y, PR_x and PR_y. Therefore, the display area DA may be driven by being divided into a plurality of areas, and a ratio or size of each of the plurality of areas may be freely adjusted in first and second directions X and Y. That is, the ratio or size of each of the areas in the display area DA is adjustable or variable.

The gate driver 200 may be disposed in the non-display area NDA. The gate driver 200 may include a scan driver 210 and an emission control driver 220. The scan driver 210 may supply the first and second scan signals SCAN1 and SCAN2 to the first and second scan lines 12 and 14, respectively, and the emission control driver 220 may supply the emission control signal EM to the emission control line 16.

Each of the scan driver 210 and the emission control driver 220 may operate by receiving a plurality of gate control signals supplied through the timing controller 400 through the level shifter 500.

The data driver 300 may convert digital data supplied together with data control signals from the timing controller 400 into analog data signals and supply the data voltage Vdata to the data line 22 of the display panel 100. The data driver 300 may subdivide a plurality of reference gamma voltages supplied from the gamma voltage generator 600 and convert the digital data into analog data voltages by using the subdivided gamma voltages.

Also, the data driver 300 may generate the plurality of mode control signals SH_x, SH_y, PR_x and PR_y and supply the generated mode control signals SH_x, SH_y, PR_x and PR_y to the plurality of mode control lines 42x, 42y, 44x and 44y of the display panel 100, respectively. Alternatively, the plurality of mode control signals SH_x, SH_y, PR_x and PR_y may be generated by a mode controller (not shown) separated from the data driver 300 and supplied to the display panel 100 through a circuit film on which the data drive IC is packaged.

The timing controller 400 may control the gate driver 200 and the data driver 300 by using timing control signals supplied from a host system and timing setup information stored therein.

The timing controller 400 may generate and supply a plurality of gate control signals for controlling a driving timing of the gate driver 200 to the gate driver 200. Alternatively, the timing controller 400 may generate control signals for timing control and supply the control signals to the level shifter 500 so that the level shifter 500 may generate a plurality of gate control signals and supply the gate control signals to the gate driver 200.

The timing controller 400 may generate a plurality of data control signals for controlling driving timing of the data driver 300 and supply the generated data control signals to the data driver 300. Alternatively, the timing controller 400 may perform various kinds of image processing including image quality correction, deterioration correction and luminance correction for power consumption reduction by receiving input image data, and may supply the image-processed data to the data driver 300.

The level shifter 500 is supplied the control signals supplied from the timing controller 400 and then may generate a plurality of gate control signals by level shifting or logic processing. Also, the level shifter 500 supply the generated gate control signals to the scan driver 210 and the emission control driver 220.

The gamma voltage generator 600 may generate a plurality of reference gamma voltages corresponding to gamma characteristics of the display apparatus under the control of the timing controller 400 and supply the generated reference gamma voltages to the data driver 300.

The power management circuit 700 may generate and supply a plurality of driving voltages required for the operation of all circuit elements of the display apparatus by using an input voltage. That is, the power management circuit 700 may generate a first power voltage EVDD, a second power voltage EVSS and an initialization voltage Vref and supply the generated voltages to the display panel 100. Also, the power management circuit 700 may generate and supply various driving voltages required for the operation of the gate driver 200, the data driver 300, the timing controller 400, the level shifter 500 and the gamma voltage generator 600.

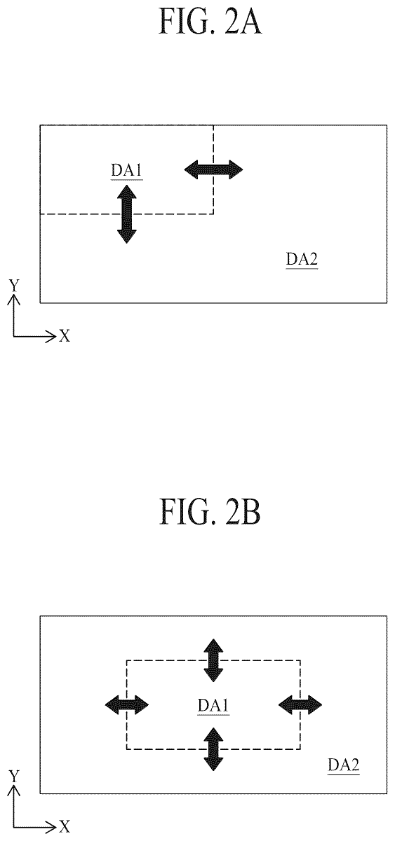

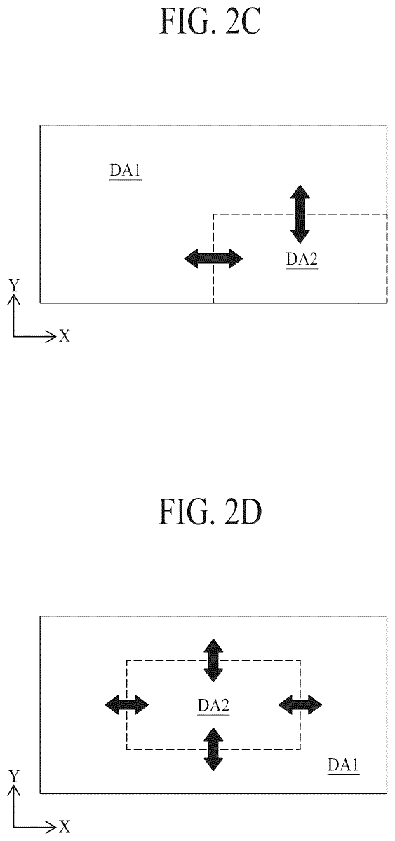

FIGS. 2A to 2D are views illustrating various forms in which a ratio of first and second display areas DA1 and DA2 are changed in a display apparatus according to one embodiment of the present disclosure.

Referring to FIGS. 2A to 2D, the display area DA of the display panel 100 may include a first display area DA1 and a second display area DA2. The first display area DA1 may be a first mode (SH) area according to the (1-1)th and (1-2)th mode control signals SH_x and SH_y, and the second display area DA2 may be a second mode (PR) area according to the (2-1)th and (2-2)th mode control signals PR_x and PR_y. For example, the first mode (SH) area may be a share mode area, and the second mode (PR) area may be a privacy mode area.

In FIGS. 2A to 2D, the first direction X may be expressed as a left-right direction, a horizontal direction, a parallel direction or an X-axis direction. Also, the second direction Y is a direction perpendicular to the first direction X, and may be expressed as an up and down direction, a vertical direction, a perpendicular direction or a Y-axis direction.

Referring to FIG. 2A, the first display area DA1 may be an area extended in the first and second directions X and Y from left and upper ends of the display area DA (e.g., an upper left corner), and the second display area DA2 may be the remaining area the display area DA excluding the first display area DA1. That is, the first and second display areas DA1 and DA2 are non-overlapping with each other. Also, the first display area DA1 may be extended in the first direction X so as to contact a right end of the display area DA. Also, the first display area DA1 may be extended in the second direction Y so as to contact a lower end of the display area DA.

Referring to FIG. 2B, the first display area DA1 may be an area extended in the first and second directions X and Y from the center of the display area DA, and the second display area DA2 may a remaining area of the display area DA excluding the first display area DA1. That is, the first and second display areas DA1 and DA2 are non-overlapping with each other. Also, the first display area DA1 may be extended in the first direction X so as to contact a left end or a right end of the display area DA. Also, the first display area DA1 may be extended in the second direction Y so as to contact an upper end or a lower end of the display area DA.

Referring to FIG. 2C, the second display area DA2 may be an area extended in the first and second directions X and Y from the lower right corner of the display area DA, and the first display area DA1 may be a remaining area of the display area DA excluding the second display area DA2. That is, the first and second display areas DA1 and DA2 are non-overlapping with each other. Also, the second display area DA2 may be extended in the first direction X so as to contact the right end of the display area DA. Also, the second display area DA2 may be extended in the second direction Y so as to contact the lower end of the display area DA.

Referring to FIG. 2D, the second display area DA2 may be an area extended in the first and second directions X and Y from the center of the display area DA, and the first display area DA1 may a remaining area of the display area DA excluding the second display area DA2. That is, the first and second display areas DA1 and DA2 may be non-overlapping with each other. Also, the second display area DA2 may be extended in the first direction X so as to contact a left end or a right end of the display area DA. Also, the second display area DA2 may be extended in the second direction Y so as to contact an upper end or a lower end of the display area DA.

In addition to the shown examples of FIGS. 2A to 2D, the ratio and sizes of the first and second display areas DA1 and DA2 may vary in various forms along the first and second directions X and Y.

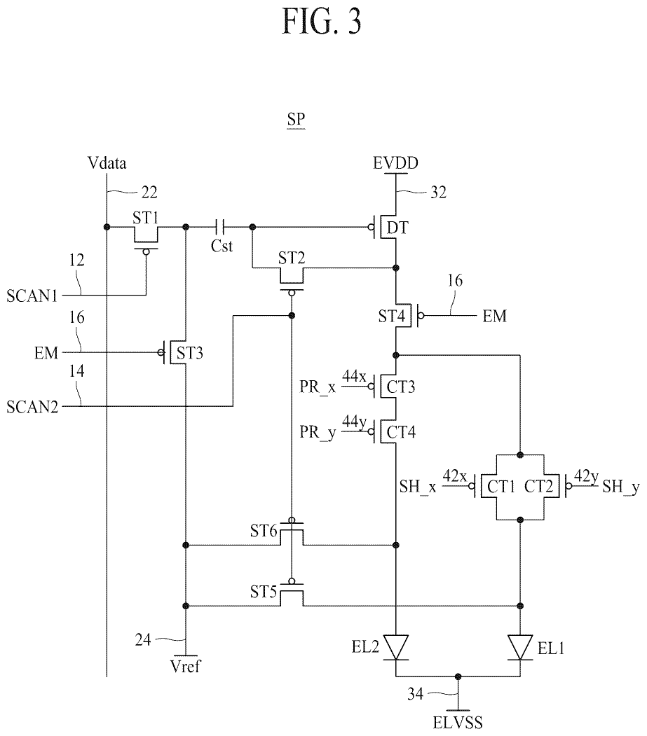

FIG. 3 is a circuit view illustrating one subpixel SP of a display apparatus according to one embodiment of the present disclosure.

One subpixel SP may include a plurality of transistors DT, ST1 to ST6 and CT1 to CT4, a plurality of light emitting elements EL1 and EL2 and a storage capacitor Cst. The plurality of transistors DT, ST1 to ST6 and CT1 to CT4 may include a driving transistor DT, first to sixth switching transistor ST1 to ST6, and (1-1)th, (1-2)th, (2-1)th and (2-2)th mode control transistors CT1 to CT4.

Each of the plurality of transistors DT, ST1 to ST6 and CT1 to CT4 of each subpixel SP includes a gate electrode, a source electrode and a drain electrode. Since the source electrode and the drain electrode may be changed depending on a direction of a voltage and a current, which are applied to the gate electrode, without being fixed, one of the source electrode and the drain electrode may be expressed as a first electrode, and the other one may be expressed as a second electrode.

Each subpixel SP may be driven to include an initial period, a sampling period, a program period and an emission period per frame period.

The plurality of light emitting elements EL1 and EL2 may include first and second light emitting elements EL1 and EL2. The first light emitting element EL1 may include an anode connected to the (1-1)th and (1-2)th mode control transistors CT1 and CT2 and a cathode supplied with the second power voltage EVSS from the second power line 34. In addition, the second light emitting element EL2 may include an anode connected to the (2-2)th mode control transistor CT4 and a cathode supplied with the second power voltage EVSS from the second power line 34.

The first light emitting element EL1 may be supplied with the driving current from the driving transistor DT through the (1-1)th and (1-2)th mode control transistors CT1 and CT2 (e.g., a plurality of first mode control transistors), and the second light emitting element EL2 may be supplied with the driving current from the driving transistor DT through the (2-1)th and (2-2)th mode control transistors CT3 and CT4 (e.g., a plurality of second mode control transistors). Therefore, the first and second light emitting elements EL1 and EL2 may emit light of brightness proportional to a current value of the driving current.

A first electrode of the driving transistor DT may be connected to the first power line 32 for supplying the first power voltage EVDD. As described above, the first power voltage EVDD may be supplied from the power management circuit 700. A second electrode of the driving transistor DT may be connected to first electrodes of the (1-1)th and (1-2)th mode control transistors CT1 and CT2 and the (2-1)th mode control transistor CT3 through the fourth switching transistor ST4. The driving transistor DT may drive the first light emitting element EL1 through the fourth switching transistor ST4 and the (1-1)th and (1-2)th mode control transistors CT1 and CT2, or may drive the second light emitting element EL2 through the fourth switching transistor ST4 and the (2-1)th and (2-2)th mode control transistors CT3 and CT4.

The driving transistor DT may control the emission intensity of the first light emitting element EL1 or the second light emitting element EL2 through the (1-1)th and (1-2)th mode control transistors CT1 and CT2 and the (2-1)th and (2-2)th mode control transistors CT3 and CT4 by controlling a driving current Ids in accordance with a driving voltage Vgs of the storage capacitor Cst.

The storage capacitor Cst may be connected between the gate electrode and the first electrode of the driving transistor DT to charge the driving voltage Vgs corresponding to the data voltage Vdata. During the emission period for which the first switching transistor ST1 is turned off, the storage capacitor Cst may maintain the charged driving voltage Vgs and supply the same to the driving transistor DT.

The first switching transistor ST1 may operate in accordance with the first scan signal SCAN1 applied through the first scan line 12. Also, the first switching transistor ST1 may supply the data voltage Vdata supplied through the data line 22 to a first electrode of the storage capacitor Cst for the sampling period and the program period.

The second switching transistor ST2 may operate in accordance with the second scan signal SCAN2 applied through the second scan line 14. During the initialization period, the sampling period and the program period, the second switching transistor ST2 may connect the driving transistor DT in a diode structure by connecting the gate electrode with the second electrode (or the drain electrode) of the driving transistor DT. The second switching transistor ST2 may charge the storage capacitor Cst with a threshold voltage Vth of the driving transistor DT. Therefore, during the initial period, the sampling period and the program period, the storage capacitor Cst may charge the data voltage Vdata+Vth compensated for the threshold voltage Vth of the driving transistor DT.

The third switching transistor ST3 may operate in accordance with the emission control signal EM. During the initial period and the emission period, the third switch transistor T3 may supply the initialization voltage Vref supplied through the initialization voltage line 24 to the first electrode of the storage capacitor Cst.

The fourth switching transistor ST4 may operate in accordance with the emission control signal EM. During the initial period and the emission period, the fourth switching transistor ST4 may connect the driving transistor DT to the (1-1)th, (1-2)th, (2-1)th and (2-2)th mode control transistors CT1 to CT4.

The fifth switching transistor ST5 may operate in accordance with the second scan signal SCAN2. During the initial period, the sampling period and the program period, the fifth switching transistor ST5 may supply the initialization voltage Vref supplied through the initialization voltage line 24 to the anode of the first light emitting element EL1.

The sixth switching transistor ST6 may operate in accordance with the second scan signal SCAN2. During the initial period, the sampling period and the program period, the sixth switching transistor ST6 may supply the initialization voltage Vref supplied through the initialization voltage line 24 to the anode of the second light emitting element EL2.

Each of the plurality of mode control transistors CT1 to CT4 may operate in accordance with a mode control signal. The (1-1)th mode control transistor CT1 may operate in accordance with a (1-1)th mode control signal SH_x, and the (1-2)th mode control transistor CT2 may operate in accordance with a (1-2)th mode control signal SH_y. In addition, the (2-1)th mode control transistor CT3 may operate in accordance with a (2-1)th mode control signal PR_x, and the (2-2)th mode control transistor CT4 may operate in accordance with a (2-2)th mode control signal PR_y.

The (1-1)th and (1-2)th mode control signals SH_x and SH_y and the (2-1)th and (2-2)th mode control signals PR_x and PR_y may be supplied from the data driver 300 or a mode controller (not shown). When each subpixel SP operates in the first mode SH, the (1-1)th and (1-2)th mode control signals SH_x and SH_y may be activated to a gate-on voltage, and the (2-1)th and (2-2)th mode control signals PR_x and PR_y may be deactivated to a gate-off voltage. When each subpixel SP operates in the second mode PR, the (1-1)th and (1-2)th mode control signals SH_x and SH_y may be deactivated to the gate-off voltage, and the (2-1)th and (2-2)th mode control signals PR_x and PR_y may be activated to the gate-on voltage.

The first electrode of each of the (1-1)th and (1-2)th mode control transistors CT1 and CT2 may be connected to the fourth switching transistor ST4, and a second electrode of each of the (1-1)th and (1-2)th mode control transistors CT1 and CT2 may be connected to the first light emitting element EL1. That is, the (1-1)th and (1-2)th mode control transistors CT1 and CT2 may constitute a parallel circuit.

The (1-1)th and (1-2)th mode control transistors CT1 and CT2 may connect the driving transistor DT with the first light emitting element EL1 during a light emitting period at which the fourth switching transistor ST4 is turned on by the light emitting control signal EM. In this case, when at least one of the (1-1)th and (1-2)th mode control transistors CT1 and CT2 is turned on, the driving current of the driving transistor DT is supplied to the first light emitting element EL1 so that the first light emitting element EL1 may emit light. Also, when both the (1-1)th and (1-2)th mode control transistors CT1 and CT2 are turned off, the first light emitting element EL1 may not emit light.

A first electrode of the (2-1)th mode control transistor CT3 may be connected to the fourth switching transistor ST4, and a second electrode of the (2-1)th mode control transistor CT3 may be connected to the first electrode of the (2-2)th mode control transistor CT4. Also, the second electrode of the (2-2)th mode control transistor CT4 may be connected to the second light emitting element EL2. That is, the (2-1)th and (2-2)th mode control transistors CT3 and CT4 may constitute a series circuit.

The (2-1)th and (2-2)th mode control transistors CT3 and CT4 may connect the driving transistor DT with the second light emitting element EL2 during the emission period at which the fourth switching transistor ST4 is turned on by the emission control signal EM. In this case, when both the (2-1)th and (2-2)th mode control transistors CT3 and CT4 are turned on, the driving current of the driving transistor DT may be supplied to the second light emitting element EL2 so that the second light emitting element EL2 may emit light. Also, when at least one of the (2-1)th and (2-2)th mode control transistors CT3 and CT4 is turned off, the second light emitting element EL2 may not emit light.

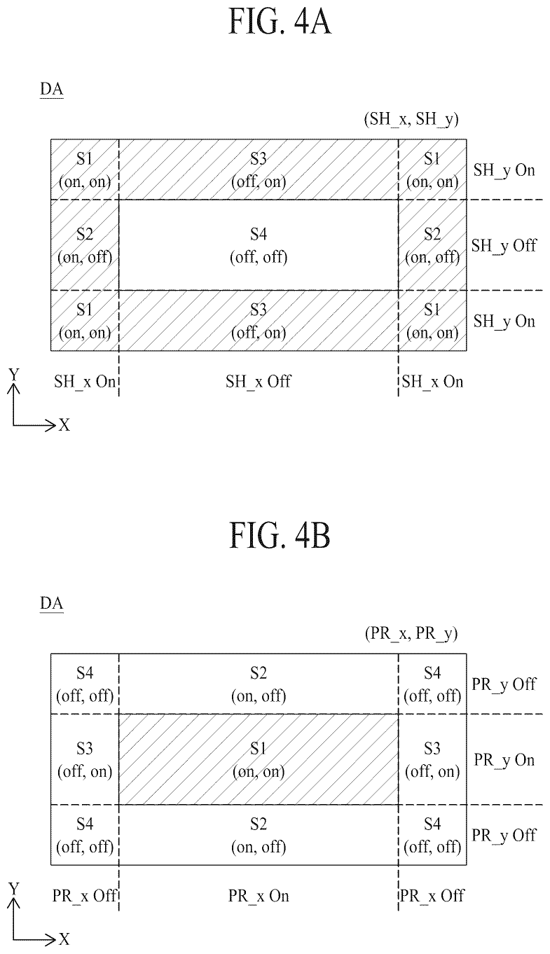

FIGS. 4A and 4B are views illustrating driving areas of first and second modes SH and PR according to a plurality of control signals SH_x, SH_y, PR_x and PR_y in a display apparatus according to one embodiment.

FIG. 4A illustrates a driving area of the first mode SH according to the (1-1)th and (1-2)th mode control signals SH_x and SH_y. The (1-1)th mode control signal SH_x may divide the display area DA in accordance with the first direction X, and the (1-2)th mode control signal SH_y may divide the display area DA in accordance with the second direction Y. That is, the display area DA may be divided to be driven in horizontal and vertical directions through the (1-1)th and (1-2)th mode control signals SH_x and SH_y. Thus, the (1-1)th and (1-2)th mode control signals SH_x and SH_y control the size of the first display area DA1 for example.

Each subpixel SP of the display area DA may be one of first to fourth states S1 to S4 in accordance with the (1-1)th and (1-2)th mode control signals SH_x and SH_y. In detail, in the first state S1, both the (1-1)th and (1-2)th mode control signals SH_x and SH_y may be gate-on voltages. In the second state S2, the (1-1)th mode control signal SH_x may be a gate-on voltage, and the (1-2)th mode control signal SH_y may be a gate-off voltage. In the third state S3, the (1-1)th mode control signal SH_x may be a gate-off voltage, and the (1-2)th mode control signal SH_y may be a gate-on voltage. In the fourth state S4, both the (1-1)th and (1-2)th mode control signals SH_x and SH_y may be gate-off voltages.

As described above with reference to FIG. 3, when at least one of the (1-1)th or (1-2)th mode control transistor CT1 or CT2 is turned on, the first light emitting element EL1 may emit light. That is, when at least one of the (1-1)th or (1-2)th mode control signal SH_x or SH_y is activated to a gate-on voltage, the first mode SH may be operated. Therefore, in one of the first to third states S1 to S3, the subpixel SP may operate in the first mode SH. Also, in the fourth state S4, the subpixel SP cannot operate in the first mode SH (e.g., is off).

Referring to FIG. 4A, since an edge area of the display area DA is in any one of the first to third states S1 to S3, it may operate in the first mode SH. Also, since a central area of the display area DA is in the fourth state S4, it cannot operate in the first mode SH.

FIG. 4B illustrates a driving area of the second mode PR according to the (2-1)th and (2-2)th mode control signals PR_x and PR_y. The (2-1)th mode control signal PR_x may divide the display area DA in accordance with the first direction X, and the (2-2)th mode control signal PR_y may divide the display area DA in accordance with the second direction Y. That is, the display area DA may be divided to be driven in horizontal and vertical directions through the (2-1)th and (2-2)th mode control signals PR_x and PR_y.

Each subpixel SP of the display area DA may be one of first to fourth states S1 to S4 in accordance with the (2-1)th and (2-2)th mode control signals PR_x and PR_y. In detail, in the first state S1, both the (2-1)th and (2-2)th mode control signals PR_x and PR_y may be gate-on voltages. In the second state S2, the (2-1)th mode control signal PR_x may be a gate-on voltage, and the (2-2)th mode control signal PR_y may be a gate-off voltage. In the third state S3, the (2-1)th mode control signal PR_x may be a gate-off voltage, and the (2-2)th mode control signal PR_y may be a gate-on voltage. In the fourth state S4, both the (2-1)th and (2-2)th mode control signals PR_x and PR_y may be gate-off voltages.

As described above with reference to FIG. 3, when both the (2-1)th or (2-2)th mode control transistor CT3 and CT4 are turned on, the second light emitting element EL2 may emit light. That is, when both the (2-1)th and (2-2)th mode control signal PR_x or PR_y are activated to gate-on voltages, the second mode PR may be operated. Therefore, in the first state S1, the subpixel SP may operated in the second mode PR. Also, in one of the second to fourth states S2 to S4, the subpixel SP cannot operate in the second mode PR (e.g., is off).

Referring to FIG. 4B, since a central area of the display area DA is in the first state S1, it cannot be operated in the second mode PR. Also, since an edge area of the display area DA is in any one of the second to fourth states S2 to S4, it cannot be operated in the second mode PR.

In this case, referring to FIGS. 4A and 4B, the (1-1)th mode control signal SH_x and the (2-1)th mode control signal PR_x may be activated to opposite voltages, and the (1-2)th mode control signal SH_y and the (2-2)th mode control signal PR_y may be activated to opposite voltages. In detail, when the (1-1)th mode control signal SH_x is activated to a gate-on voltage, the (2-1)th mode control signal PR_x may be activated to a gate-off voltage. In addition, when the (1-2)th mode control signal SH_y is activated to a gate-on voltage, the (2-2)th mode control signal PR_y may be activated to a gate-off voltage.

Therefore, the edge area of the display area DA may operate in the first mode SH, and the central area of the display area DA may operate in the second mode PR. That is, areas driven by the first and second modes SH and PR may not overlap each other. Therefore, each of the subpixels SP is driven in one of the first mode SH or the second mode PR, and one subpixel SP cannot be simultaneously operated in the first and second modes SH and PR. Therefore, the display area DA may be driven to be divided in the first and second modes SH and PR.

FIGS. 4A and 4B disclose that the display area DA is driven by being divided into a central area and an edge area, but are not limited thereto.

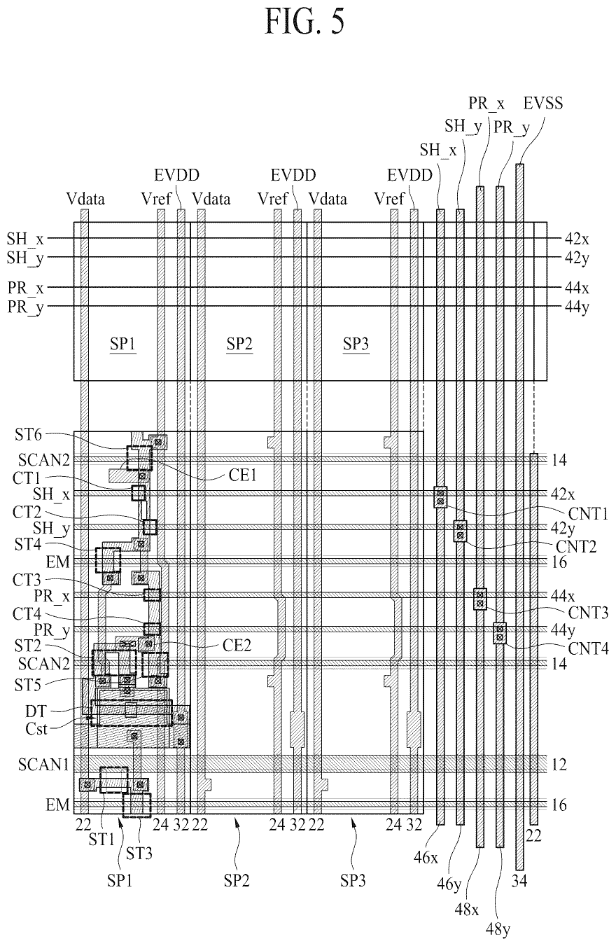

FIG. 5 is a plan view illustrating an arrangement structure of subpixels in a display apparatus according to one embodiment of the present disclosure.

Referring to FIG. 5, an arrangement structure of main signal lines in the first to third subpixels SP1, SP2 and SP3 and a planar arrangement structure of the first subpixel SP1 are exemplarily illustrated. As described above in FIG. 3, the first subpixel SP1 may include a plurality of transistors DT, ST1 to ST6 and CT1 to CT4, a plurality of light emitting elements EL1 and EL2 and a storage capacitor Cst.

The first subpixel SP1 may include a first scan line 12 and an emission control line 16, which are disposed in the first direction X at a lower area, and a second scan line 14, an emission control line 16, a (1-1)th mode control line 42x, a (1-2)th mode control line 42y, a (2-1)th mode control line 44x and a (2-2)th mode control line 44y, which are disposed at an upper area, based on the driving transistor DT and the storage capacitor Cst. Also, the subpixel SP may include a data line 22, an initialization voltage line 24 and a first power line 32, which are disposed in the second direction Y.

The driving transistor DT may include a semiconductor layer overlapped with the storage capacitor Cst, a first electrode (source electrode) connected to a first power line 32 for supplying a first power voltage EVDD, and a second electrode (drain electrode) connected to the first electrode (source electrode) of the second switching transistor ST2.

The first switching transistor ST1 may include a semiconductor layer overlapped with the first scan line 12 for supplying the first scan signal SCAN1, a first electrode (source electrode) connected to the data line 22 for supplying the data voltage Vdata, and a second electrode (drain electrode) connected to a first electrode of the storage capacitor Cst.

The second switching transistor ST2 may include a semiconductor layer overlapped with the second scan line 14 for supplying the second scan signal SCAN2, a first electrode (source electrode) connected to the second electrode (drain electrode) of the driving transistor DT, and a second electrode (drain electrode) connected to a second electrode of the storage capacitor Cst.

The third switching transistor ST3 may include a semiconductor layer overlapped with the emission control line 16 for supplying the emission control signal EM, a first electrode (source electrode) connected to the initialization voltage line 24 for supplying the initialization voltage Vref, and a second electrode (drain electrode) connected to the first electrode of the storage capacitor Cst.

The fourth switching transistor ST4 may include a semiconductor layer overlapped with the emission control line 16 for supplying an emission control signal EM, a first electrode (source electrode) connected to the second electrode (drain electrode) of the driving transistor DT, and a second electrode (drain electrode) connected to a first electrode (source electrode) of the (1-1)th mode control transistor CT1 and a first electrode (source electrode) of a (2-1)th mode control transistor CT3.

The fifth switching transistor ST5 may include a semiconductor layer overlapped with the second scan line 14 for supplying the second scan signal SCAN2, a first electrode (source electrode) connected to the initialization voltage line 24 for supplying the initialization voltage Vref, and a second electrode (drain electrode) connected to a first connection electrode CE1 and the second electrodes (drain electrodes) of the (1-2)th and (1-2)th mode control transistors CT1 and CT2. The first connection electrode CE1 may be connected to the anode of the first light emitting element EL1.

The sixth switching transistor ST6 may include a semiconductor layer overlapped with the second scan line 14 for supplying the second scan signal SCAN2, a first electrode (source electrode) connected to the initialization voltage line 24 for supplying the initialization voltage Vref, and a second electrode (drain electrode) connected to a second connection electrode CE2 and the second electrode (drain electrode) of the (2-2)th mode control transistor CT4. The second connection electrode CE2 may be connected to the anode of the second light emitting element EL2.

The (1-1)th mode control transistor CT1 may include a semiconductor layer overlapped with the (1-1)th mode control line 42x for supplying the (1-1)th mode control signal SH_x, a first electrode (source electrode) connected to the second electrode (drain electrode) of the fourth switching transistor ST4 and the first electrode (source electrode) of the (1-2)th mode control transistor CT2, and a second electrode (drain electrode) connected to the first contact electrode CE1 connected to the anode of the first light emitting element EL1.

The (1-2)th mode control transistor CT2 may include a semiconductor layer overlapped with the (1-2)th mode control line 42y for supplying the (1-2)th mode control signal SH_y, a first electrode (source electrode) connected to the second electrode (drain electrode) of the fourth switching transistor ST4 and the first electrode (source electrode) of the (1-1)th mode control transistor CT1, and a second electrode (drain electrode) connected to the first contact electrode CE1 connected to the anode of the first light emitting element EL1.

The (2-1)th mode control transistor CT3 may include a semiconductor layer overlapped with the (2-1)th mode control line 44x for supplying the (2-1)th mode control signal PR_x, a first electrode (source electrode) connected to the second electrode (drain electrode) of the fourth switching transistor ST4, and a second electrode (drain electrode) connected to the first electrode (source electrode) of the (2-2)th mode control transistor CT4.

The (2-2)th mode control transistor CT4 may include a semiconductor layer overlapped with the (2-2)th mode control line 44y for supplying the (2-2)th mode control signal PR_y, a first electrode (source electrode) connected to the second electrode (drain electrode) of the (2-1)th mode control transistor CT3, and a second electrode (drain electrode) connected to the second connection electrode CE2 connected to the anode of the second light emitting element EL2.

The (1-1)th and (1-2)th mode signal supply lines 46x and 46y and the (2-1)th and (2-2)th mode signal supply lines 48x and 48y, which are disposed in the second direction Y, may be disposed in parallel with the first power line 32 of the third subpixel SP3. Also, the (1-1)th and (1-2)th mode signal supply lines 46x and 46y may be respectively connected to the (1-1)th and (1-2)th mode control lines 42x and 42y disposed in the first direction X through first and second contact holes CNT1 and CNT2, respectively. Also, the (2-1)th and (2-2)th mode signal supply lines 48x and 48y may be respectively connected to the (2-1)th and (2-2)th mode control lines 44x and 44y disposed in the first direction X through third and fourth contact holes CNT3 and CNT4, respectively.

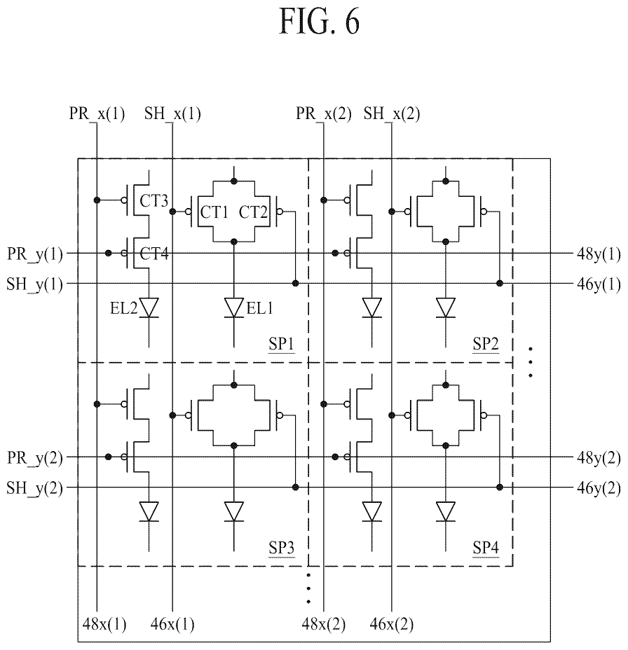

Referring to FIG. 5, the (1-1)th and (1-2)th mode signal supply lines 46x and 46y and the (2-1)th and (2-2)th mode signal supply lines 48x and 48y are disclosed as being all disposed on one side of the third subpixel SP3, but are not limited thereto. Another example will be described in FIGS. 6 to 8 below.

FIG. 6 is a view illustrating an arrangement structure of a plurality of mode signal supply lines 46x, 46y, 48x and 48y in a display apparatus according to one embodiment of the present disclosure.

Referring to FIG. 6, the first to fourth subpixels SP1 to SP4 disposed in the form of a matrix are shown. In FIG. 6, a structure in which the first and second subpixels SP1 and SP2 are disposed in the same row and the third to fourth subpixels SP3 and SP4 are disposed in the same row is disclosed, but the present disclosure is not limited thereto.

Also, each of the first to fourth subpixels SP1 to SP4 includes the circuit described above in FIG. 3, and FIG. 6 shows only the (1-1)th, (1-2)th, (2-1)th and (2-2)th mode control transistors CT1 to CT4 and the first and second light emitting elements EL1 and EL2.

Referring to FIG. 6, each of the first to fourth subpixels SP1 to SP4 may be supplied with different mode control signals. In detail, the first subpixel SP1 may be supplied with (1-1)th and (2-1)th control signals SH_x(1) and PR_x(1) in a first column and (1-2)th and (2-2)th control signals PR_y(1) and SH_y(1) in a first row. The second subpixel SP2 may be supplied with (1-1)th and (2-1)th control signals SH_x(2) and PR_x(2) in a second column and the (1-2)th and (2-2)th control signals SH_y(1) and PR_y(1) in the first row. The third subpixel SP3 may be supplied with the (1-1)th and (2-1)th control signals SH_x(1) and PR_x(1) in the first column and (1-2)th and (2-2)th control signals SH_y(2) and PR_y(2) in a second row. The fourth subpixel SP4 may be supplied with the (1-1)th and (2-1)th control signals SH_x(2) and PR_x(2) in the second column and the (1-2)th and (2-2)th control signals SH_y(2) and PR_y(2) in the second row.

Therefore, all of the first to fourth subpixels SP1 to SP4 may operate in the same mode, or at least one of the first to fourth subpixels SP1 to SP4 may operate in different modes. As a result, all of the first light emitting elements EL1 of the first to fourth subpixels SP1 to SP4 may emit light or may not emit light. Alternatively, some of the first light emitting elements EL1 of the first to fourth subpixels SP1 to SP4 may emit light, or may not emit light. Likewise, all of the second light emitting elements EL2 of the first to fourth subpixels SP1 to SP4 may emit light, or may not emit light. Alternatively, some of the second light emitting elements EL2 of the first to fourth subpixels SP1 to SP4 may emit light, or may not emit light.

That is, the first to fourth subpixels SP1 to SP4 may be independently driven, so that the display area DA may be driven by being divided in vertical and horizontal directions. Also, some of the plurality of mode signal supply lines 46x, 46y, 48x and 48y may be disposed in the second direction Y, so that bezel areas on left and right sides of the display area DA may be minimized.

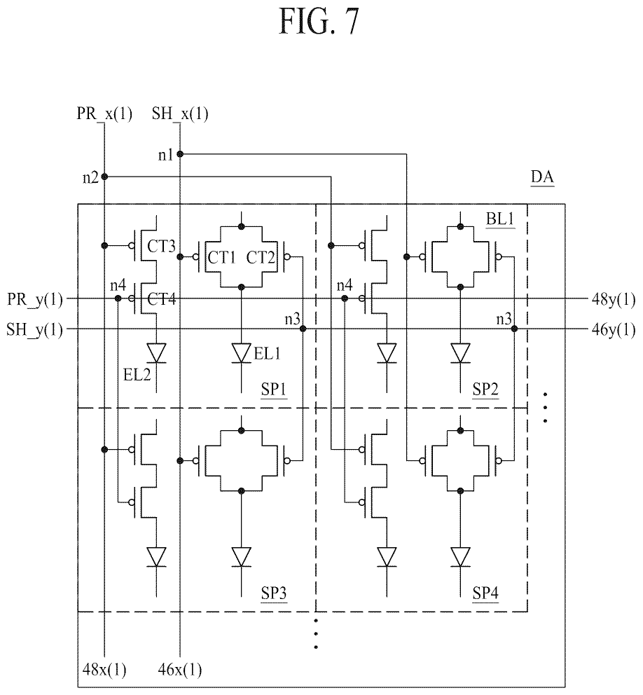

FIG. 7 is a view illustrating an arrangement structure of a plurality of mode signal supply lines 46x, 46y, 48x and 48y in a display apparatus according to another embodiment of the present disclosure.

Like FIG. 6, FIG. 7 shows the first to fourth subpixels SP1 to SP4 disposed in the form of a matrix. Also, each of the first to fourth subpixels SP1 to SP4 includes the circuit described above in FIG. 3, and FIG. 7 shows only the (1-1)th, (1-2)th, (2-1)th and (2-2)th mode control transistors CT1 to CT4 and the first and second light emitting elements EL1 and EL2.

Referring to FIG. 7, the first to fourth subpixels SP1 to SP4 may be supplied with mode control signals activated with the same voltage. In detail, a (1-1)th mode signal supply line 46x(1) may be diverged from a first node n1 to supply the same (1-1)th mode signal SH_x(1) to the first to fourth subpixels SP1 to SP4. A (2-1)th mode signal supply line 48x(1) may be diverged from a second node n2 to supply the same (1-2)th mode signal PR_x(1) to the first to fourth subpixels SP1 to SP4. A (1-2)th mode signal supply line 46y(1) may be diverged from a third node n3 to supply the same (2-1)th mode signal SH_y(1) to the first to fourth subpixels SP1 to SP4. A (2-2)th mode signal supply line 48y(1) may be diverged from a fourth node n4 to supply the same (2-2)th mode signal PR_y(1) to the first to fourth subpixels SP1 to SP4.

Therefore, all of the first to fourth subpixels SP1 to SP4 may operate in the same mode. As a result, all of the first light emitting elements EL1 of the first to fourth subpixels SP1 to SP4 may emit light, or may not emit light. Likewise, all of the second light emitting elements EL2 of the first to fourth subpixels SP1 to SP4 may emit light, or may not emit light.

In this case, the first to fourth subpixels SP1 to SP4 driven in the same mode may be regarded as a first block BL1, and the display area DA may include a plurality of blocks BL. That is, the plurality of subpixels SP included in one block BL may be driven in the same mode, so that the display area DA may be driven by being divided in vertical and horizontal directions for the unit of block BL. In comparison with FIG. 6, in the embodiment of FIG. 7, since the display area DA may be divided for the unit of block BL, the number of lines of the plurality of mode signal supply lines 46x, 46y, 48x and 48y may be reduced.

Also, although FIG. 7 shows that one block BL includes first to fourth subpixels SP1 to SP4 and the number of subpixels SP disposed in parallel with the first direction X is the same as the number of subpixels SP disposed in parallel with the second direction Y, but the present disclosure is not limited thereto. For example, in one block BL, the number of subpixels SP disposed in parallel with the second direction Y may be greater than the number of subpixels SP disposed in parallel with the first direction X. Alternatively, in one block BL, the number of subpixels SP disposed in parallel with the second direction Y may be smaller than the number of subpixels SP disposed in parallel with the first direction X.

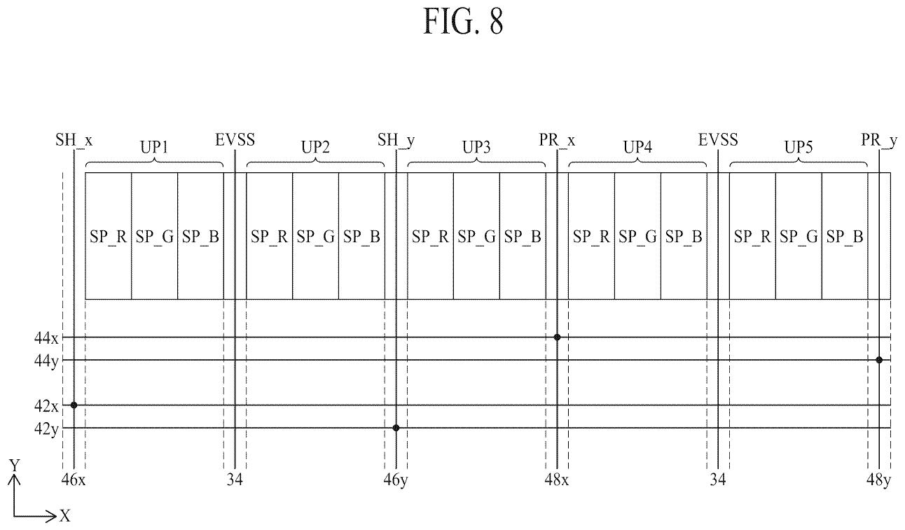

FIG. 8 is a view illustrating an arrangement structure of a plurality of mode signal supply lines 46x, 46y, 48x and 48y in a display apparatus according to another embodiment of the present disclosure.

Referring to FIG. 8, first to fifth unit pixels UP1 to UP5 disposed in parallel with the first direction X are shown. Each of the first to fifth unit pixels UP1 to UP5 may include a red subpixel SP_R, a green subpixel SP_G and a blue subpixel SP_B. Also, each of the red subpixel SP_R, the green subpixel SP_G and the blue subpixel SP_B may include the circuit described in FIG. 3.

In this case, the first to fifth unit pixels UP1 to UP5 may be defined as one block BL to receive mode control signals activated with the same voltage. Although omitted in FIG. 8, like FIG. 7, the mode signal supply lines 46x, 46y, 48x and 48y may be diverged from a plurality of nodes to supply the same mode control signals SH_x, SH_y, PR_x and PR_y to the first to fifth unit pixels UP1 to UP5. Therefore, the first to fifth unit pixels UP1 to UP5 may operate in the same mode.

In this case, the mode signal supply lines 46x, 46y, 48x and 48y and the second power line 34 for supplying and the low potential power voltage EVSS may be disposed between unit pixels UP adjacent to each other. In detail, the (1-1)th mode signal supply line 46x may be disposed on one side of the first unit pixel UP1, and the second power line 34 may be disposed on the other side of the first unit pixel UP1. Also, the second power line 34 may be disposed on one side of the second unit pixel UP2, and the (1-2)th mode signal supply line 46y may be disposed on the other side of the second unit pixel UP2. Also, the (1-2)th mode signal supply line 46y may be disposed on one side of the third unit pixel UP3, and the (2-1)th mode signal supply line 48x may be disposed on the other side of the third unit pixel UP3. Also, the (2-1)th mode signal supply line 48x may be disposed on one side of the fourth unit pixel UP4, and the second power line 34 may be disposed on the other side of the fourth unit pixel UP4. In addition, the second power line 34 may be disposed on one side of the fifth unit pixel UP5, and the (2-2)th mode signal supply line 48y may be disposed on the other side of the fifth unit pixel UP5.

In addition, the configuration of the unit pixel UP and the arrangement order of the plurality of mode signal supply lines 46x, 46y, 48x, 48y and the second power line 34 are not limited to the above example.

That is, the plurality of supply lines may not be all disposed at a specific position, but may be disposed by being divided in a non-emission area between the unit pixels UP adjacent to each other. Therefore, a size of the non-emission area between the adjacent unit pixels UP may be minimized, and an increase in the size of the non-emission area at the specific position may be avoided. In addition, the bezel area on both sides may be minimized.

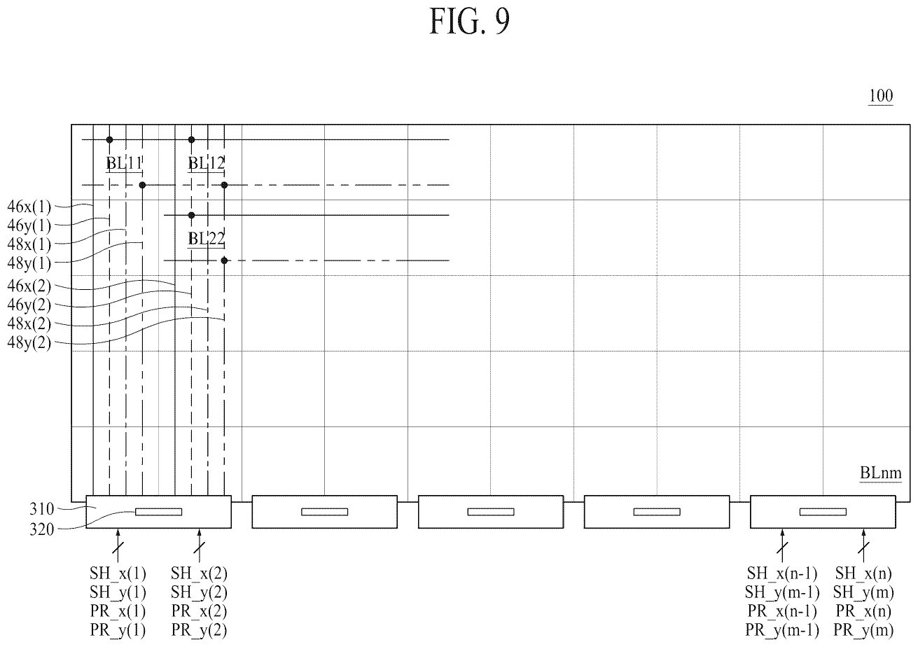

FIG. 9 is a view illustrating a schematic arrangement structure of a plurality of blocks BL in a display apparatus according to one embodiment of the present disclosure.

Referring to FIG. 9, the display area DA of the display panel 100 includes a plurality of blocks BL, and the data driver 300 may include a plurality of data drive ICs 310 and a COF 320 packaged on each of the data drive ICs 310.

The data driver 300 may be electrically connected to the plurality of blocks BL through the plurality of mode signal supply lines 46x, 46y, 48x and 48y. In detail, the first data drive IC 310 may supply the (1-1)th and (2-1)th control signals PR_x(1) and SH_x(1) in the first column, the (1-1)th and (2-1)th control signals PR_x(2) and SH_x(2) in the second column, the (1-2)th and (2-2)th control signals PR_y(1) and SH_y(1) in the first row, and the (1-2)th and (2-2)th control signals PR_y(2) and SH_y(2) in the second row. In this case, each of the plurality of blocks BL may be selectively supplied with a mode control signal through a mode control line in the subpixel SP.

Therefore, each of the plurality of blocks BL may be independently controlled through a plurality of mode control signals SH_x, SH_y, PR_x and PR_y. Therefore, each of the plurality of blocks BL may be selectively driven in the first mode SH or the second mode PR.

In addition, the data driver 300 may be disposed below the display panel 100 in a plan view of the display device 100, and the plurality of mode signal supply lines 46x, 46y, 48x and 48y may be disposed in parallel with the second direction Y, so that bezel areas on the left and right sides of the display panel 100 may be minimized.

In addition, FIG. 9 discloses that one data drive IC 310 supplies eight signals, but the present disclosure is not limited thereto. Further, the number of data drive ICs 310 and the number of mode signal supply lines connected to one data drive IC 310 may vary.

According to the present disclosure, the following advantageous effects may be obtained.

According to the present disclosure, the ratio of the plurality of display areas may be freely adjusted in the vertical and horizontal directions through the plurality of mode control signals, whereby user convenience may be improved.

It will be apparent to those skilled in the art that the present disclosure described above is not limited by the above-described embodiments and the accompanying drawings and that various substitutions, modifications and variations may be made in the present disclosure without departing from the spirit or scope of the disclosures. Consequently, the scope of the present disclosure is defined by the accompanying claims and it is intended that all variations or modifications derived from the meaning, scope and equivalent concept of the claims fall within the scope of the present disclosure.

What is claimed is:

1. A display apparatus comprising:
a display panel having a display area in which a plurality of subpixels are disposed, each of the plurality of subpixels including:
a driving transistor connected to a first power line;
an emission control transistor connected to the driving transistor, the emission control transistor supplied with an emission control signal at a gate electrode of the emission control transistor;
a first light emitting element;
a second light emitting element, and
a plurality of mode control transistors connected to the emission control transistor, the first light emitting element, and the second light emitting element, the plurality of mode control transistors including:
a plurality of first mode control transistors connected in parallel with each other and connected to the first light emitting element; and
a plurality of second mode control transistors connected in series with each other and connected to the second light emitting element.

2. The display apparatus of claim 1, wherein a first electrode of each of the plurality of first mode control transistors is connected to the emission control transistor, and a second electrode of each of the plurality of first mode control transistors is connected to the first light emitting element.

3. The display apparatus of claim 1, wherein a first electrode of a first transistor from the plurality of second mode control transistors is connected to the emission control transistor and a second electrode of the first transistor is connected to a first electrode of a second transistor from the plurality of second mode control transistors, and a second electrode of the second transistor is connected to the second light emitting element.

4. The display apparatus of claim 1, wherein the first light emitting element emits light when at least one of the plurality of first mode control transistors is turned on, and the second light emitting element emits light when both of the plurality of second mode control transistors are turned on.

5. The display apparatus of claim 4, wherein the first light emitting element included in each subpixel of the plurality of subpixels emits light while the second light emitting element in the subpixel does not emit light, and the second light emitting element in the subpixel emits light while the first light emitting element in the subpixel does not emit light.

6. The display apparatus of claim 4, wherein a gate electrode of a first transistor included in the plurality of first mode control transistors receives a first mode control signal, a gate electrode of a second transistor included in the plurality of second mode control transistors receives a second mode control signal, a gate electrode of a first transistor included in the plurality of second mode control transistors receives a third mode control signal, and a gate electrode of a second transistor included in the plurality of second mode control transistors receives a fourth mode control signal.

7. The display apparatus of claim 6, wherein the display area is divided into a plurality of blocks that each include subpixels of the plurality of subpixels, and the subpixels included in any one of the plurality of blocks emit light simultaneously or do not emit light simultaneously.

8. The display apparatus of claim 7, wherein each of the plurality of blocks includes a first subpixel to a fourth subpixel,
wherein the first transistor included in the plurality of first mode control transistors that are respectively included in the first subpixel to the fourth subpixel are driven in a same manner,
wherein the second transistor included in the plurality of first mode control transistors that are respectively included in the first subpixel to the fourth subpixel are driven in a same manner,
wherein the first transistor included in the plurality of second mode control transistors that are respectively included in the first subpixel to the fourth subpixel are driven in a same manner, and
wherein the second transistor included in the plurality of second mode control transistors that are respectively included in the first subpixel to the fourth subpixel are driven in the same manner.

9. The display apparatus of claim 8, wherein the display panel further comprises:
a data driver that is connected to the plurality of blocks through a plurality of mode signal supply lines and the data driver configured to supply a plurality of mode control signals to each of the plurality of subpixels, the plurality of mode control signals including the first mode control signal, the second mode control signal, the third mode control signal, and the fourth mode control signal; and
wherein each of the plurality of mode signal supply lines diverges from at least one node and supplies the plurality of mode control signals to the first subpixel to the fourth subpixel.

10. The display apparatus of claim 9, wherein the data driver is disposed below the display panel in a plan view of the display apparatus, and the plurality of mode signal supply lines are disposed in a vertical direction of the display panel.

11. The display apparatus of claim 7, wherein the display panel further comprises:
a data driver is connected to the plurality of blocks through a plurality of mode signal supply lines and the data driver is configured to supply a plurality of mode control signals to each of the plurality of subpixels included in each of the plurality of blocks via the plurality of mode signal supply lines,
each of the plurality of blocks includes a plurality of unit pixels composed of red, green and blue subpixels, and
each of the plurality of mode signal supply lines is between a pair of unit pixels that are adjacent to each other.

12. The display apparatus of claim 11, wherein a mode signal supply line from the plurality of mode signal supply lines is in a non-emission area between the pair of unit pixels that are adjacent to each other.

13. The display apparatus of claim 1, wherein the driving transistor is configured to control emission intensity of the first light emitting element and the second light emitting element through the plurality of mode control transistors.

14. A display apparatus comprising:
a display panel having a first display area that emits light during a first mode but not during a second mode and a second display area that emits light during the second mode but not during the first mode, and a plurality of subpixels are disposed in the first display area and the second display area, each of the plurality of subpixels including:
a driving transistor connected to a first power line;
an emission control transistor connected to the driving transistor, the emission control transistor supplied with an emission control signal at a gate electrode of the emission control transistor;
a first light emitting element;
a second light emitting element, and
a plurality of mode control transistors including:
a plurality of first mode control transistors connected in parallel with each other and connected to the first light emitting element; and
a plurality of second mode control transistors connected in series with each other and connected to the second light emitting element,
wherein the first light emitting element emits light and the second light emitting element does not emit light in the first mode, and the second light emitting element emits light and the first light emitting element does not emit light in the second mode.

15. The display apparatus of claim 14, wherein a first electrode of each of the plurality of first mode control transistors is connected to the emission control transistor, and a second electrode of each of the plurality of first mode control transistors is connected to the first light emitting element.

16. The display apparatus of claim 15, wherein a first electrode of a first transistor from the plurality of second mode control transistors is connected to the emission control transistor and a second electrode of the first transistor is connected to a first electrode of a second transistor from the plurality of second mode control transistors, and a second electrode of the second transistor is connected to the second light emitting element.

17. The display apparatus of claim 14, wherein the first light emitting element emits light when at least one of the plurality of first mode control transistors is turned on, and the second light emitting element emits light when both of the plurality of second mode control transistors are turned on.

18. The display apparatus of claim 17, wherein the first light emitting element included in each subpixel of the plurality of subpixels emits light while the second light emitting element in the subpixel does not emit light, and the second light emitting element in the subpixel emits light while the first light emitting element in the subpixel does not emit light.

19. The display apparatus of claim 17, wherein a gate electrode of a first transistor included in the plurality of first mode control transistors receives a first mode control signal, a gate electrode of a second transistor included in the plurality of second mode control transistors receives a second mode control signal, a gate electrode of a first transistor included in the plurality of second mode control transistors receives a third mode control signal, and a gate electrode of a second transistor included in the plurality of second mode control transistors receives a fourth mode control signal.

20. The display apparatus of claim 19, wherein the first display area and the second display area are each divided into a plurality of blocks that each include subpixels of the plurality of subpixels, and the subpixels included in any one of the plurality of blocks emit light simultaneously or do not emit light simultaneously.
